(19) United States
(12) Patent Application Publication
(10) Pub. No.: US 2014/0138533 A1
(43) Pub. Date: May 22, 2014

(54) ION MASS SELECTOR, ION IRRADIATION DEVICE, SURFACE ANALYSIS DEVICE, AND ION MASS SELECTING METHOD

(71) Applicant: CANON KABUSHIKI KAISHA, Tokyo (JP)

(72) Inventor: Kota Iwasaki, Atsugi-shi (JP)

(73) Assignee: CANON KABUSHIKI KAISHA, Tokyo (JP)

(21) Appl. No.: 14/076,496

(22) Filed: Nov. 11, 2013

(30) Foreign Application Priority Data
Nov. 19, 2012 (JP) 2012-253337

(51) Int. Cl. H01J 49/40

(52) U.S. Cl. CPC H01J 49/40
USPC 250/282; 250/287

(57) ABSTRACT

A time-of-flight mass selector includes a first ion lens for converging ions, a flight tube into which ions which enter from the first ion lens are introduced, the flight tube having equipotential space therein, a second ion lens for converging ions having passed through the flight tube, and a chopper for a gate for pulsing the ions converged by the second ion lens.

### BACKGROUND OF THE INVENTION

1. Field of the Invention

The present invention relates to an ion mass selector for selecting ions in accordance with the mass-to-charge ratio using the relationship between ion flight time and kinetic energy.

2. Description of the Related Art

A cluster ion beam can be obtained by, through electron impact or photoionization, ionizing clustered particles formed by injecting high-pressure gas from a nozzle into a vacuum or clustered particles formed by cooling vapor of a solid.

Further, without the ionizing step, by directly ionizing charged liquid droplets or the surface of a solid or a liquid by field evaporation, a cluster ion beam formed of clustered particles can be generated.

Irradiation of a solid surface with cluster ions is used in a surface treatment such as etching, sputtering, and deposition. Further, when cluster ions having high masses are incident, there is obtained such an effect that fragmentation is suppressed and still high molecules can be ionized. Therefore, application of cluster ion irradiation to a surface analysis device is also effective (Japanese Patent Application Laid-Open No. 2011-29043). In such application, it is necessary to control the beam current of cluster ions, the cluster size, or the irradiation time.

A cluster ion irradiation device includes a cluster ion generating part, a mass selector, a beam control part, and an irradiation part. The respective parts are evacuated by a vacuum pump and construct a vacuum chamber as a whole.

Cluster ions generated by the cluster ion generating part generally include clusters of various sizes, and thus, it is often the case that, after such cluster ions enter the mass selector, cluster ions having a predetermined size are selected and then incident on an object.

Mass selecting methods include a magnetic sector type, a quadrupole type, a time-of-flight type, and the like. The time-of-flight type is suitable for cluster ions having high masses. Time-of-flight mass selection is a method of, when the ion flight distance is known, based on the relationship between the flight time and the kinetic energy of ions which are pulsed before mass selection (a pulse which is a reference for measurement of ion flight time is herein referred to as a trigger pulse), selecting ions in accordance with the masses thereof.

Note that, the relationship between ion flight time and mass is a function expressed by Equation 1.

$$\frac{m}{z} = 2 {eV ( \frac{t}{L} )}^{2} \qquad Equation 1$$

where m is the mass of an ion, z is the charge number of the ion, t is the flight time of the ion in an equipotential space, V is the voltage applied to the ion during passage, L is the distance of flight, and e is the elementary charge.

Mass-selected cluster ions are subjected to control of acceleration/deceleration and convergence/divergence by the beam control part. After that, an object to be processed or a sample placed on the irradiation part is irradiated with the cluster ions.

The sample or the like is irradiated with the cluster ions in a DC manner or in a pulse manner. In particular, when the cluster ions are incident as primary ions for measurement by a time-of-flight mass spectrometer of secondary ions generated by the ion irradiation, that is, for a so-called Time-Of-Flight Secondary Ion Mass Spectrometer (TOF-SIMS), irradiation in a pulse manner on the order of microseconds or shorter is required.

On the other hand, a cluster ion beam includes cluster ions each formed of several molecules (dimer, trimer, tetramer and so on) and large cluster ions each formed of more than 10,000 molecules (10,000-mer), and may even include a monomer ion formed of a single molecule which does not form a cluster.

When such cluster ions are used as the above-mentioned primary ions, a problem arises in that the flight time t of the cluster ions considerably differ between a case in which cluster ions having high masses are selected as the primary ions and a case in which cluster ions having masses which are smaller by several digits are selected as the primary ions.

The relationship between a flight time t and a time difference Δt of an ion, and a mass m and a mass difference Δm of the ion is expressed by Equation 2 presented in the below. Generally, the minimum value of Δt is equal to the duration of the trigger pulse, and thus, when the duration of the trigger pulse is constant, the mass resolution (Δm/m) varies in accordance with the mass of the ion. The reason is that it is difficult to adjust as the need arises the distance of flight which depends on the size of the device.

$$\frac{Δ m}{m} = 2 \frac{Δ t}{t} \qquad Equation 2$$

When the mass resolution is sought to be controlled, the duration of the trigger pulse or the ion flight time t varies in accordance with the mass of the ion, and thus, it is necessary to adjust any one of the two.

When cluster ions are used as primary ions of a TOF-SIMS, the duration of an incident pulse determines the mass resolution of secondary ions of the TOF-SIMS. Therefore, variation of the duration of the trigger pulse is not preferred, and the ion flight time is required to be adjusted. As shown in Equation 1, the ion flight time t is expressed as a function of the energy which the ion passing through the equipotential space has (pass energy).

Therefore, in order to control the mass resolution independently of the duration of the trigger pulse, it is necessary to adjust the pass energy in accordance with the mass of the ion. By way of example, to change the mass m when the duration of the trigger pulse and the mass difference Δm of the primary ions are constant applies to such a case.

However, when the pass energy is changed, the trajectories of cluster ions which enter the time-of-flight mass selector are also changed, and there is a problem that the efficiency of passage of the cluster ions through the time-of-flight mass selector varies.

### SUMMARY OF THE INVENTION

In view of the above-mentioned problem, an object of the present invention is to provide a time-of-flight ion mass selector which can carry out mass selection of cluster ions having considerably different masses with high efficiency.

According to one embodiment of the present invention, there is provided a time-of-flight mass selector, including: a first ion lens for converging ions; a flight tube into which ions which enter from the first ion lens are introduced, the flight tube having equipotential space therein; a second ion lens for converging ions which have passed through the flight tube; and a chopper for a gate for pulsing the ions converged by the second ion lens.

According to one embodiment of the present invention, it is possible to provide a time-of-flight ion mass selector which can carry out mass selection of cluster ions having different masses.

Further features of the present invention will become apparent from the following description of exemplary embodiments with reference to the attached drawings.

### BRIEF DESCRIPTION OF THE DRAWINGS

FIG. 1A illustrates a cluster ion irradiation device.

FIG. 1B illustrates an ion mass selector according to one embodiment of the present invention.

FIG. 2A illustrates a result of ion optical simulation of the ion mass selector.

FIG. 2B illustrates a result of ion optical simulation in which part of the ions pass.

FIG. 2C illustrates a result of ion optical simulation of a chopper.

FIG. 2D illustrates a result of ion optical simulation in which the voltage applied to an entrance lens and the voltage applied to an exit lens are different from each other.

FIG. 3A is a graph showing the relationship between VL and transmittance (Vtof=7.5 kV or 9.0 kV).

FIG. 3B is a graph showing the relationship between Vtof and transmittance when the entrance lens and the exit lens are out of action (VL=Vtof).

FIG. 3C is a graph showing the relationship between Vtof and transmittance (VL=8.5 kV).

FIG. 4A illustrates an ion mass selector including a control part.

FIG. 4B illustrates an ion mass selector including an outgoing aperture electrode.

FIG. 5 is a graph showing the relationship between mass m and pass energy Epass of cluster ions.

### DESCRIPTION OF THE EMBODIMENTS

### First Embodiment

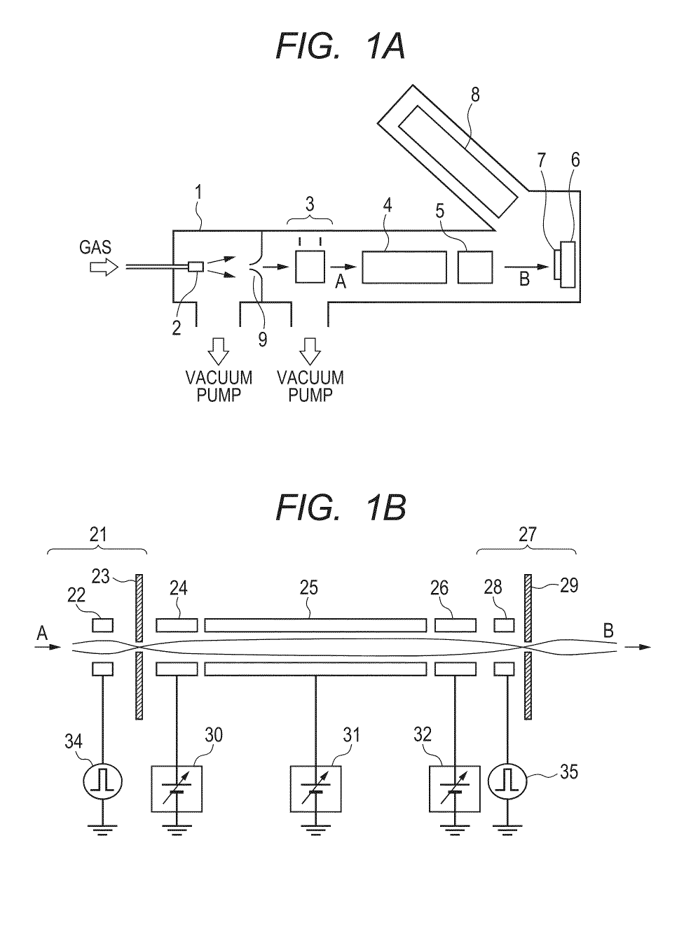

A method of operating a surface analysis device including a cluster ion irradiation device which has a time-of-flight mass selector according to a first embodiment of the present invention is described with reference to FIGS. 1A and 1B.

The cluster ion irradiation device according to this embodiment includes a nozzle 2, an ionizing part 3, a mass selector 4, a converging lens 5, and an irradiation stage 6. These parts form a vacuum chamber 1. The cluster ion irradiation device according to this embodiment further includes a vacuum exhaust system and a signal processing system (not shown) (FIG. 1A).

A noble gas such as Ar, Ne, He, or Kr, a molecular gas such as CO₂, CO, N₂, O₂, NO₂, SF₆, Cl₂, or NH₄, an alcohol such as (ethanol, methanol, or isopropyl alcohol), water, and the like are supplied through a gas introduction pipe to the nozzle 2. The water or the alcohol may be mixed with an acid or a base.

A gas introduction pressure is not particularly limited. The gas introduction pressure may be within the range of 0.001 atm to 100 atm, and preferably be 0.1 atm to 20 atm.

When gas is injected from the nozzle 2 into the vacuum chamber 1, the gas or liquid which is supplied is accelerated to a supersonic speed and thus cooled by adiabatic expansion, and gas including clusters which are aggregations of atoms or molecules is generated.

At least any one of the clusters or the gas enters the ionizing part 3 through a skimmer 9. An electron source such as a hot filament is placed in the ionizing part 3. Electrons generated by the electron source ionize atoms or molecules which form clusters to generate a cluster ion beam A.

Cluster ions and monomer ions having various sizes are generated in the ionizing part 3. The cluster ion beam A including them enters the mass selector 4 and is subjected to mass selection by the mass selector 4.

As illustrated in FIG. 1B, the mass selector 4 includes a chopper 21 for a trigger, an entrance lens (first ion lens) 24, a flight tube 25, an exit lens (second ion lens) 26, and a chopper 27 for a gate.

The chopper 21 for a trigger includes a parallel plate deflector 22 for a trigger and an aperture electrode 23 for a trigger. An appropriate voltage Vpass is applied from a power supply 34 to the deflector 22 for a trigger in a pulse manner (trigger pulse) to cause the cluster ion beam A to pass through the aperture electrode 23 for a trigger. When Vpass is not applied, Vstop is applied by the power supply 34 to shut off the cluster ion beam A. It is preferred to select as Vpass a voltage which causes, when the voltage is applied, at least part of ions including ions to be selected among ions included in the cluster ion beam A to pass through the aperture electrode 23. Further, it is preferred to select as Vstop a voltage which causes, when the voltage is applied, the trajectories of ions in the cluster ion beam A to be deflected so that the ions do not pass through the aperture electrode. Operation to generate pulsed ions by causing the ions to pass only for a predetermined time period in the direction of travel thereof is herein referred to as chopping.

Note that, the pulsed cluster ion beam A can also be obtained by using, instead of the chopper 21 for a trigger, a nozzle for injecting gas in a pulse manner or an ionizing part for ionizing clusters in a pulse manner.

Voltage is applied to the entrance lens 24 from a power supply 30 (first power supply) and voltage is applied to the exit lens 26 from a power supply 32 (third power supply), so that the cluster ion beam A which enters the flight tube 25 and the cluster ions which have passed through the flight tube 25 are converged by the electric fields, respectively. Voltage is applied to the flight tube 25 from a power supply 31 (second power supply) so that the inside thereof becomes equipotential space. The cluster ion beam A passes through the aperture electrode 23 for a trigger, and then, after being converged by the entrance lens 24, enters the flight tube 25. The cluster ions move at a constant speed in the equipotential space in the flight tube 25. In this process, mass dispersion (differentiation of flight time) of the cluster ions and the monomer ions is caused in accordance with the mass-to-charge ratios thereof. Note that, the flight tube may have a cylindrical shape, but may also have any shape insofar as the flight tube has an equipotential space therein. For example, the flight tube may have a space which is polygonal in section existing therein.

The cluster ions which have passed through the flight tube 25 are converged again by the exit lens 26, and then enter the chopper 27 for a gate.

In this embodiment, the entrance lens 24 and the exit lens 26 are coaxial and cylindrical electrostatic lenses, but aperture electrostatic lenses may be used, or a magnetic lens may be used.

Otherwise, any one of the entrance lens 24 and the exit lens 26 may be omitted, and a simple structure including only one of those lenses may be provided. Such a configuration may be attained not only by eliminating an electrode but also by causing the potential of any one of the entrance lens 24 and the exit lens 26 to be the same as the potential of the flight tube 25 or the aperture electrode.

The chopper 27 for a gate also includes a parallel plate deflector 28 for a gate and an aperture electrode 29 for a gate, and, similarly to the chopper 21 for a trigger, chops cluster ions.

Note that, instead of the deflector 22 for a trigger and the deflector 28 for a gate, a retarding electrode to which high voltage is applied for reflecting ions or a plate with an aperture which rotates at high speed may be used to chop the cluster ion beam A. Further, instead of the application of voltage to the electrodes, magnetic fields may be used to deflect the trajectories of the ions in the cluster ion beam A.

Mass dispersion is caused along the direction of travel with regard to the cluster ions which pass through the flight tube 25, and thus, mass selection can be carried out by applying Vpass to the deflector 28 for a gate in a pulse manner at the timing at which cluster ions having a certain mass pass through the aperture electrode 29 for a gate (hereinafter referred to as a gate pulse). Note that, a mass-selected cluster ion beam B is, at this time, in the shape of pulses also with regard to time.

The duration of the gate pulse is the same as or may be longer than the duration of the trigger pulse. The reason is that, when the duration of the gate pulse becomes shorter than the duration of the trigger pulse, part of cluster ions which pass through the mass selector 4 cannot be used, and the current value of cluster ions which are incident on a sample may be substantially reduced.

By adjusting the duration of the gate pulse, only cluster ions having a target mass can be selected, or, a pulse-like ion beam including two or more cluster ion groups having different masses may also be formed.

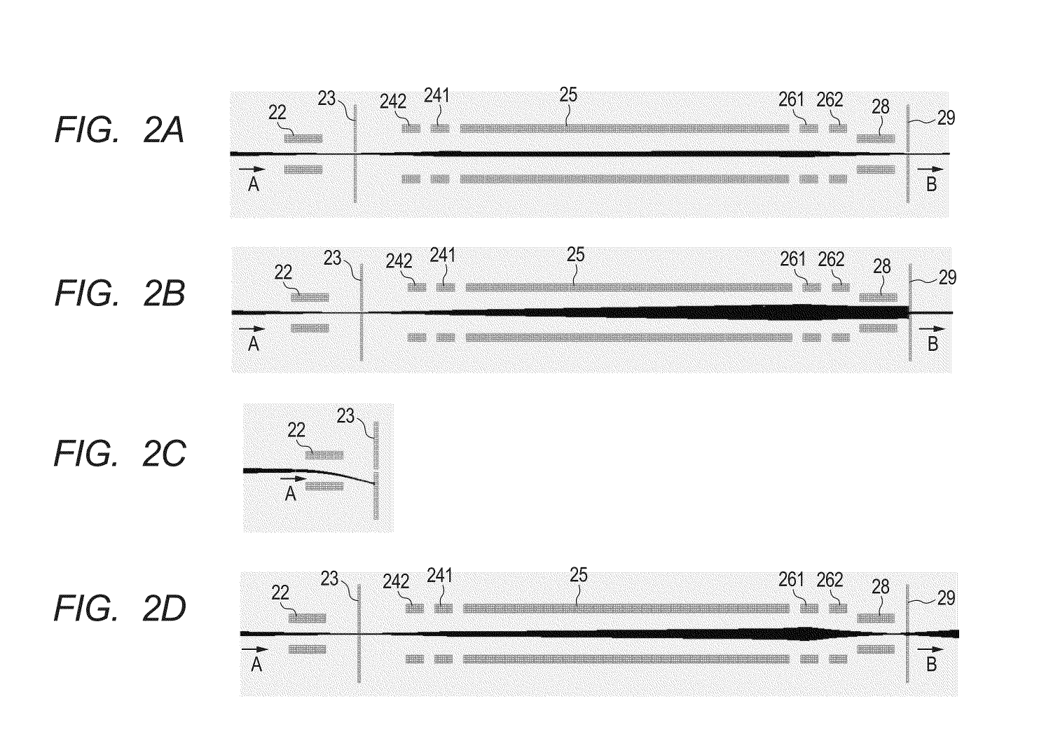

FIG. 2A illustrates the result of ion optical simulation of cluster ions having positive charge which are derived from the ionizing part 3 under the condition where an acceleration voltage Vacc is 10 [kV].

The flight tube 25 is a cylindrical electrode having a length of 340 [mm] and a diameter of 40 [mm]. The entrance lens 24 and the exit lens 26 are coaxial cylindrical electrodes both having a length of 20 [mm] and a diameter of 40 [mm]. Note that, the length of the flight tube 25 is approximately equal to L in Equation 1. The distance between the aperture electrode 23 for a trigger and the aperture electrode 29 for a gate is 570 [mm]. The distance between the aperture electrode and the deflector is 30 [mm] with regard to both the chopper 21 for a trigger and the chopper 27 for a gate.

The voltage Vtof applied to the flight tube 25 is 7.5 [kV]. From the energy conservation law, the relationship expressed in Equation 3 holds, and thus, the pass energy Epass of the cluster ions is 2.5 [keV].

eV=E_{pzss}+eV_{tof} Equation 3

The aperture electrode 23 for a trigger and the aperture electrode 29 for a gate are grounded. Both the apertures have a diameter of 2 [mm].

In FIG. 2A, voltage of 8.5 [kV] is applied to a primary entrance lens 241 included in the entrance lens 24, and voltage of 0 [kV] is applied to an auxiliary entrance lens 242 also included in the entrance lens 24. Similarly, voltage of 8.5 [kV] is applied to a primary exit lens 261 included in the exit lens 26, and voltage of 0 [kV] is applied to an auxiliary exit lens 262 included in the exit lens 26.

The cluster ion beam A converged by a lens (not shown) forms a crossover at the opening in the aperture electrode 23 for a trigger (first crossover point). By controlling the trajectory of the cluster ion beam A so that the crossover exists, the acceptance angle of the mass selector 4 becomes wider, which is advantageous. Note that, however, the effect of the present invention is attained even without the formation of the crossover.

The cluster ion beam A which passes through the opening in the aperture electrode 23 for a trigger is converged by the entrance lens 24, and then, enters the flight tube 25. The cluster ions emitted from the flight tube 25 are converged by the exit lens 26 and forms a crossover at the opening in the aperture electrode 29 for a gate (second crossover point). Note also that the effect of the present invention is attained even without the formation of the crossover.

In this case, by causing the focal length of the entrance lens 24 and the focal length of the exit lens 26 to be equal to each other, the incident angle of the cluster ion beam A and the exit angle of the cluster ion beam B can be set equal to each other.

On the other hand, in FIG. 2B, voltage applied to all of the primary entrance lens 241, the auxiliary entrance lens 242, the primary exit lens 261, and the auxiliary exit lens 262 is 7.5 [kV], which is the same as the voltage applied to the flight tube 25. In this case, the cluster ion beam A is not converged, and thus, part of the ions cannot pass through the opening in the aperture electrode 29 for a gate for the mass selection, and the efficiency of passage of the ions through the aperture electrode 29 for a gate (hereinafter referred to as transmittance) is reduced.

Note that, in this embodiment, when voltage of 2.0 [kV] is applied to the deflector 22 for a trigger as Vstop, as illustrated in FIG. 2C, the deflector 22 for a trigger deflects the cluster ion beam A so as to be shut off by the aperture electrode 23 for a trigger. On the other hand, Vpass is 0 [V]. By repeating application of Vpass (first operation mode) and application of Vstop (second operation mode) for certain durations, the cluster ion beam A can be pulsed.

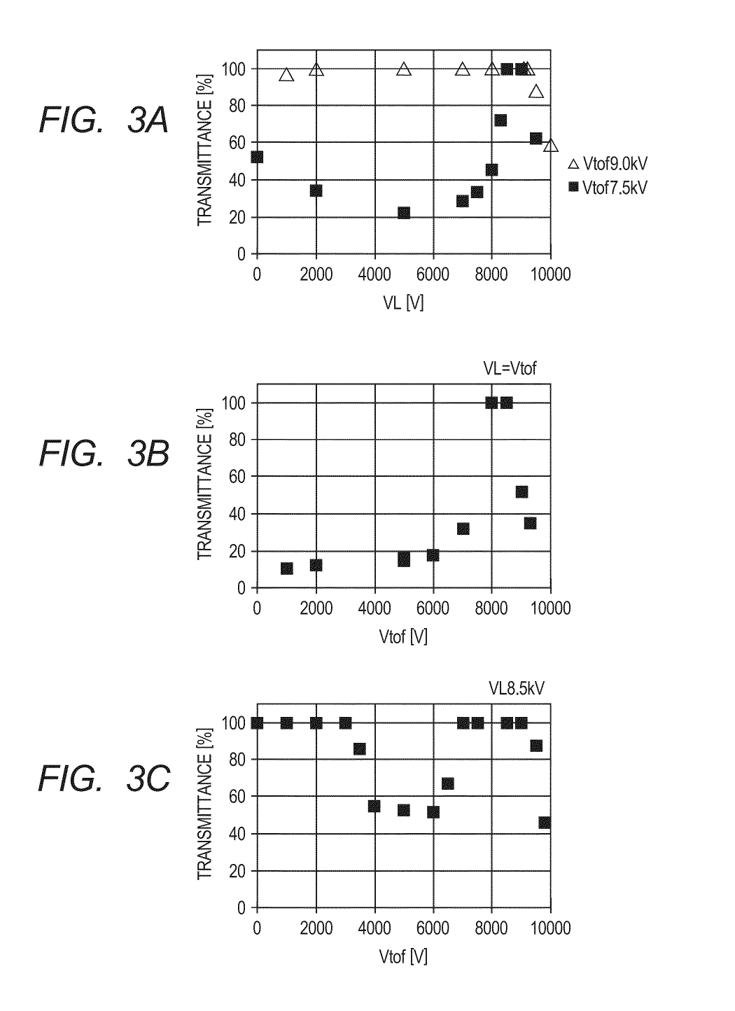

FIG. 3A shows the dependence on VL of the transmittance through the aperture electrode 29 for a gate of the cluster ions which enter the aperture electrode 23 for a trigger when the same voltage VL is applied to the entrance lens 24 and the exit lens 26. Note that, the incident angle of the cluster ions is in the range of −3 to +3 degrees. In the following, in this embodiment, unless otherwise specified, the same voltage VL is applied to the entrance lens 24 and the exit lens 26.

In this embodiment, as described above, Vtof is 7.5 [kV] and VL is 8.5 [kV]. Therefore, the transmittance is approximately 100%. On the other hand, when VL is the same as Vtof and is 7.5 [kV], the characteristics are substantially similar to those of a conventional time-of-flight mass selector in which the entrance lens 24 and the exit lens 26 do not have the intrinsic function as a lens. In this case, the transmittance is reduced to about 30% (solid black squares in FIG. 3A, see also FIG. 2B).

Therefore, according to this embodiment, by setting VL to be 8.5 [kV], the transmittance of the cluster ions is improved about three times.

Hollow triangles in FIG. 3A show the dependence on VL of transmittance when Vtof is 9.0 [kV] and the pass energy Epass is 1.0 [keV] and when mass selection of cluster ions is carried out.

The dependence on VL is different from that when Vtof is 7.5 [kV], but it can be seen that, by setting VL to be about 2.0 to 9.0 [kV], even if the pass energy is changed in accordance with the mass of the cluster ions, transmittance of almost 100% can be attained.

From FIG. 3A, it can be seen that, even if Vtof is changed for the purpose of setting Epass to an appropriate value, by setting VL to be a voltage at which the transmittance of the ions is at the maximum in the corresponding Vtof, mass selection of the cluster ions can be carried out with good efficiency.

Further, even when the acceleration voltage Vacc is changed to change the kinetic energy of the cluster ions which pass through the mass selector 4, similarly, by adjusting VL, mass selection of the cluster ions can be carried out with good efficiency. In the present invention, ions can be selected according to its mass, dependent on the relationship between the ion flight time and the kinetic energy. The relationship between ion flight time and mass is a function expressed by Equation 1. That is, in the present invention, kinetic energy of ions in the equipotential space can be determined as a function of masses of the ions.

In this case, in order to make a comparison with a conventional technology, FIG. 3B shows the dependence of transmittance on pass energy when VL and Vtof are the same. When Vtof is changed, the transmittance is considerably varied. It can be seen that, as a result, when, for the purpose of carrying out mass selection of cluster ions having considerably different sizes, Vtof is changed to change the pass energy Epass, the transmittances of the cluster ions will considerably vary.

In this way, the entrance lens 24 and the exit lens 26 converge the trajectories of the ions before and after the flight tube 25 by the electric fields generated between electrodes, and thus, even when the pass energy Epass is changed, collision of cluster ions with the electrodes is suppressed to enable increase in the efficiency of pass of the cluster ions through the mass selector 4.

The cluster ion beam B after being subjected to the mass selection and the pulsing is accelerated/decelerated and focused by the converging lens 5, and then is incident on an object 7 to be irradiated held on the irradiation stage 6.

When cluster ions are incident on the object 7 to be irradiated, the irradiation may be of a scan type in which the cluster ions are converged to scan the sample, or the irradiation may be of a projection type in which the irradiation is made collectively to a specified region of the object 7 to be irradiated.

Charged particles or neutral particles such as secondary ions which are generated from the object 7 to be irradiated are analyzed by an analysis device 8. Usage of a time-of-flight secondary ion mass spectrometer as the analysis device 8 enables secondary ion mass spectrometry using the cluster ions. Usage of a neutral particle detector with an ionizer as the analysis device 8 enables neutral particle mass spectrometry using the cluster ions. A secondary ion mass spectrometer using the cluster ion irradiation device which has the ion mass selector according to one embodiment of the present invention can control the mass resolutions or the masses of incident ions without changing the duration of the incident pulse which affects the mass resolution of the secondary ions.

Note that, in this embodiment, cluster ions are described by way of example, but the present invention is also applicable to, other than cluster ions, molecule ions, fullerene ions, and charged liquid droplets.

Ions referred to herein include various kinds of cluster ions. A cluster means an object in which two or more atoms or molecules are coupled by interaction between them. A Cluster ion means a charged cluster. Further, cluster ions may be formed of atoms or molecules of a single kind, or may be formed of atoms or molecules of two or more kinds.

Further, an ion source is not limited to the above-mentioned combination of the nozzle 2 and the ionizing part 3, and particles which are caused to be in clusters by cooling vapor from a solid may be subjected to electron impact or photoionization, or charged liquid droplets or the surface of a solid or a liquid may be directly ionized by field evaporation. The ion source may be in any one of gaseous form, liquid form, solid form, or a mixture thereof, and a metal such as gold or bismuth may be caused to be cluster ions.

In this embodiment, as described above, the voltage applied to the entrance lens 24 and the voltage applied to the exit lens 26 are the same, but the two voltages may be different from each other. As an example, FIG. 2D illustrates the result of ion optical simulation in which voltage of 7.0 [kV] is applied to the primary entrance lens 241, voltage of 0 [kV] is applied to the auxiliary entrance lens 242, voltage of 8.5 [kV] is applied to the primary exit lens 261, and voltage of 0 [kV] is applied to the auxiliary exit lens 262. It can be seen that, also in FIG. 2D, collision of cluster ions with the electrodes is suppressed and the efficiency of pass of the cluster ions through the mass selector 4 is high.

### Second Embodiment

This embodiment is similar to the above-mentioned cluster ion irradiation device except for the operating conditions of the mass selector.

The acceleration voltage Vacc of the cluster ions is set to be 10 [kV], and the voltage Vtof applied to the flight tube 25 is set to be 0 to 9 [kV]. From Equation 3, the pass energy Epass is 10 to 1 [keV].

As an example, voltage of 8.5 [kV] is applied to both the primary entrance lens 241 included in the entrance lens 24 and the primary exit lens 261 included in the exit lens 26.

The aperture electrode 23 for a trigger, the aperture electrode 29 for a gate, the auxiliary entrance lens 242, and the auxiliary exit lens 262 are grounded.

As shown in FIG. 3C, in regions in which the voltage Vtof applied to the flight tube 25 is 0 to 3 [kV] and 7 to 9 [kV], the transmittance of the cluster ions which enter the aperture electrode 23 for a trigger through the aperture electrode 29 for a gate exhibits a broad maximum. In the regions, the transmittance is approximately 100% and constant irrespective of the voltage applied to the flight tube 25. In other words, in the regions, a value obtained by differentiating the transmittance with respect to the voltage Vtof applied to the flight tube is substantially zero.

Therefore, this embodiment has an effect that, when VL is set to be 8.5 [kV], the transmittance is held constant, and still, the pass energy Epass of the cluster ions can be freely changed in the ranges in which Vtof is 7 to 10 [keV] and 1 to 3 [keV]. Similarly, by setting VL to be an appropriate value, with regard to any different values of pass energy Epass (adjusted by changing Vtof) which optimize the mass resolutions of cluster ions having different masses, cluster ions having different masses can be selected with high transmittance without changing VL.

### Third Embodiment

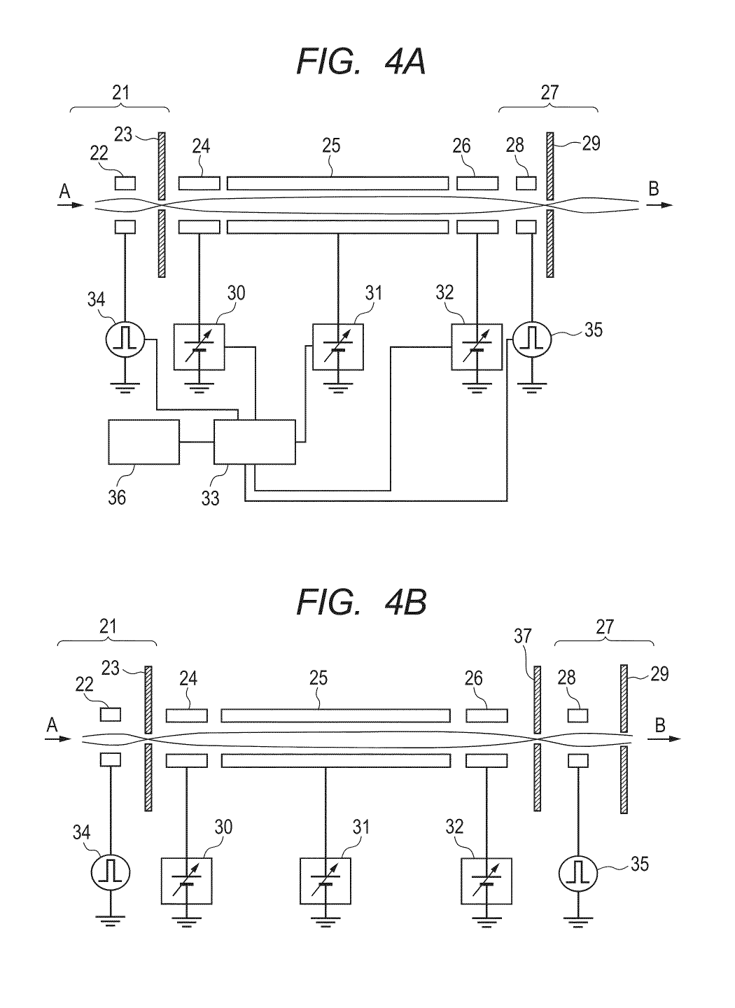

A cluster ion irradiation device according to this embodiment (FIG. 4A) is similar to the device illustrated in FIG. 1B except for the inclusion of a control part 33 connected to the entrance lens power supply 30, the flight tube power supply 31, and the exit lens power supply 32 and of a storing part 36.

The control part 33 calculates the value of the voltage Vtof applied to the flight tube so that the voltage Vacc when the cluster ions are generated and the intended Epass satisfy Equation 3.

Then, the control part 33 refers to the relationship between Vtof and the transmittance (shown in FIG. 3A) which is stored in advance in the storing part 36, and determines VL so that the transmittance is, for example, 100% with regard to a predetermined value of Epass.

The control part 33 sends as data the value of Vtof to the flight tube power supply 31, and sends as data the value of VL to the entrance lens power supply 30 and to the exit lens power supply 32. The flight tube power supply 31, the entrance lens power supply 30, and the exit lens power supply 32 supply voltages for the electrodes based on the received values, respectively.

By, through such control, setting Vtof so as to correspond to different pass energies Epass for optimizing the mass resolution of the cluster ions having different masses, respectively, and setting VL so as to match Vtof, control can be exerted so that the mass selector 4 has high transmittance.

### Fourth Embodiment

A cluster ion irradiation device according to this embodiment is similar to the device of the first embodiment except for the operating conditions of the mass selector 4.

In this embodiment, the mass of the cluster ions which are incident on the object 7 to be irradiated is changed. At that time, for mass spectrometry of charged particles or neutral particles such as secondary ions which are generated from the object 7 to be irradiated using a time-of-flight secondary ion mass spectrometer, the duration of the trigger pulse and the duration of the gate pulse of the mass selector 4 are caused to be constant. The reason is that variations in mass resolution of the time-of-flight secondary ion mass spectrometer are required to be suppressed.

The pass energy Epass of the mass selector 4 can be determined based on Equation 4 in a case in which a duration t_{gp} of the gate pulse and the mass resolution of the mass selector 4 (Δm/m) are held at 1 [μsec] and 1/100, respectively, with regard to the mass m of desired cluster ions. Vtof is determined from Equation 3.

$${t}_{gp} = \frac{L}{\sqrt{2 {E}_{pass}}} ( \sqrt{m + \frac{1}{2 Δ m}} - \sqrt{m - \frac{1}{2} Δ m} ) = const \qquad Equation 4$$

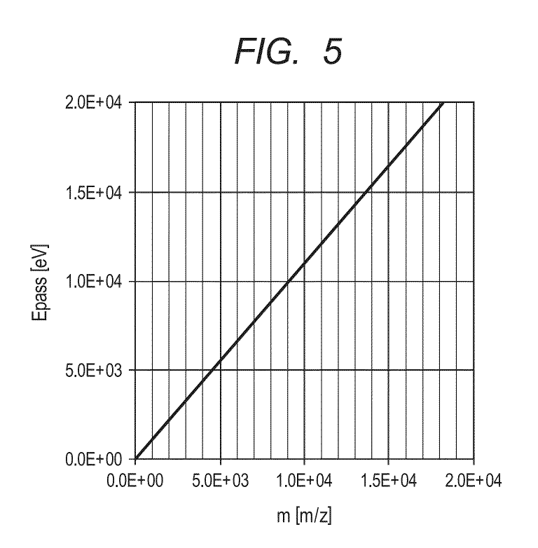

FIG. 5 shows the relationship between the mass m and the appropriate pass energy Epass of the cluster ions. Note that, calculation is done assuming L is 0.3 [m].

For example, with regard to cluster ions having a mass of 10,000 [m/z], when Epass is set to be 11 [keV], the cluster ion beam B having the above-mentioned pulse width and mass resolution is obtained.

By, through such control, causing the pulse width of the cluster ion beam B to be constant, the duration of generation of the secondary ions can be held constant and variation in mass resolution of the secondary ion mass spectrometer can be suppressed.

### Fifth Embodiment

An ion mass selector according to this embodiment (FIG. 4B) is similar to that of the first embodiment except that an outgoing aperture electrode 37 (first aperture electrode) is added and the chopper 27 for a gate is provided downstream therefrom.

According to this embodiment, the deflector 28 for a gate and the exit lens 26 are separated by the outgoing aperture electrode 37, and thus, there is an effect that influence of a leakage electric field of the deflector 28 for a gate on the trajectory of the cluster ion beam B is suppressed.

Note that, similarly, by providing, on the side of the chopper 21 for a trigger, a structure having the first aperture electrode 23 provided between the deflector for a trigger and the flight tube 25 and a second aperture electrode (not shown) provided on the opposite side of the deflector 22 for a trigger with respect to the first aperture electrode 23, influence of a leakage electric field of the deflector 22 for a trigger on the trajectory of the cluster ion beam which flies upstream from the chopper 21 for a trigger can be suppressed.

The time-of-flight mass selector according to one embodiment of the present invention can be, in combination with an ion source and a stage for holding an object to be irradiated on which ions are incident, used as a cluster ion irradiation device. Further, the time-of-flight mass selector according to one embodiment of the present invention can be, in combination with a detector for detecting neutral particles or charged particles emitted from an object to be irradiated, used as a surface analysis device. Further, when a secondary ion mass spectrometer is used as a detector in a surface analysis device, the time-of-flight mass selector according to one embodiment of the present invention can be used as part of the detector.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-253337, filed Nov. 19, 2012, which is hereby incorporated by reference herein in its entirety.

What is claimed is:

1. A time-of-flight mass selector, comprising:
a first ion lens for converging ions;
a flight tube into which ions which enter from the first ion lens are introduced, the flight tube having equipotential space therein;
a second ion lens for converging ions which have passed through the flight tube; and
a chopper for a gate for pulsing the ions converged by the second ion lens.

2. The time-of-flight mass selector according to claim 1, wherein the mass selector is configured to be operated such that a voltage is applied to at least one of the first ion lens or the second ion lens to maximize transmittance of ions in the flight tube in relationship between the voltage applied to the at least one of the first ion lens or the second ion lens and the transmittance.

3. The time-of-flight mass selector according to claim 1, wherein the mass selector is configured to be operated such that a voltage is applied to at least one of the first ion lens or the second ion lens to have a region of voltage applied to the flight tube, in which a value obtained by differentiating transmittance of ions in the flight tube with respect to the voltage applied to the flight tube is zero, exist in relationship between the transmittance and the voltage applied to the flight tube.

4. The time-of-flight mass selector according to claim 1, wherein the first ion lens and the second ion lens have the same focal length.

5. The time-of-flight mass selector according to claim 1, wherein:
the chopper for a gate comprises an aperture electrode and a deflector; and
the time-of-flight mass selector has a first operation mode in which the ions pass through the aperture electrode and a second operation mode in which at least part of the ions are shut off by the aperture electrode.

6. The time-of-flight mass selector according to claim 5, wherein the chopper for a gate comprises:
a first aperture electrode provided between the deflector and the flight tube; and
a second aperture electrode provided on an opposite side of the deflector with respect to the first aperture electrode.

7. The time-of-flight mass selector according to claim 1, further comprising a chopper for a trigger for pulsing ions, the chopper for a trigger being provided on an opposite side of the flight tube with respect to the first ion lens.

8. The time-of-flight mass selector according to claim 7, wherein:
the chopper for a trigger comprises an aperture electrode and a deflector; and
the time-of-flight mass selector has a first operation mode in which the ions pass through the aperture electrode and a second operation mode in which at least part of the ions are shut off by the aperture electrode.

9. The time-of-flight mass selector according to claim 8, wherein the chopper for a trigger comprises:
a first aperture electrode provided between the deflector and the flight tube; and
a second aperture electrode provided on an opposite side of the deflector with respect to the first aperture electrode.

10. The time-of-flight mass selector according to claim 7, wherein when ions pass through the chopper for a trigger, trajectories of the ions have a first crossover point, and when the ions pass through the chopper for a gate, the trajectories of the ions have a second crossover point.

11. The time-of-flight mass selector according to claim 7, wherein duration of pulsing ions by the chopper for a gate is equal to or longer than duration of pulsing ions by the chopper for a trigger.

12. The time-of-flight mass selector according to claim 1, further comprising:
a first power supply for applying voltage to the first ion lens;
a second power supply for applying voltage to the flight tube;
a third power supply for applying voltage to the second ion lens; and
a control part for controlling the first power supply, the second power supply, and the third power supply,
wherein the control part performs processings of:
(1) calculating a value of flight tube voltage to be applied to the flight tube based on pass energy of predetermined ions;
(2) calculating voltage to be applied to the first ion lens and voltage to be applied to the second ion lens so that, when the flight tube voltage is applied to the flight tube, the transmittance of ions has a predetermined value; and
(3) sending data of the voltage to be applied to the first ion lens and of the voltage to be applied to the second ion lens to the first power supply and the third power supply, respectively.

13. The time-of-flight mass selector according to claim 1, wherein kinetic energy of the ions in the equipotential space is determined as a function of masses of the ions.

14. A cluster ion irradiation device, comprising:
an ion source;
the time-of-flight mass selector according to claim 1; and
a stage for holding an object to be irradiated on which ions are incident.

15. A surface analysis device, comprising:
an ion source;
the time-of-flight mass selector according to claim 1;
a stage for holding an object to be irradiated on which ions are incident; and
a detector for detecting one of neutral particles and charged particles that are emitted from the object to be irradiated.

16. The surface analysis device according to claim 15, wherein the detector includes a secondary ion mass spectrometer.

17. A time-of-flight mass selecting method, comprising:
converging ions by a first ion lens;
causing the converged ions to fly in a flight tube having equipotential space therein;
converging, by a second ion lens, ions emitted from the flight tube; and
pulsing the ions converged by the second ion lens.

18. The time-of-flight mass selecting method according to claim 17, wherein kinetic energy of the ions in the equipotential space is determined as a function of masses of the ions.

19. The time-of-flight mass selecting method according to claim 17, wherein voltage applied to at least one of the first ion lens or the second ion lens is different from voltage applied to inside of the flight tube.
